(19) United States
(12) Patent Application Publication
(10) Pub. No.: US 2006/0092583 A1
(43) Pub. Date: May 4, 2006

(54) Switch array and power management system for batteries and other energy storage elements

(76) Inventors: Mahmoud A. Alahmad, Pullman, WA (US); Vinesh Sukumar, Boise, ID (US); Fadl Nasser Zghoul, Moscow, ID (US); Kevin M. Buck, Pullman, WA (US); Herbert L. Hess, Moscow, ID (US); Harry Li, Little Rock, AR (US); David Cox, Tucson, AZ (US); Mohammad M. Mojarradi, La Canada, CA (US)

Correspondence Address: Ormiston & McKinney, PLLC;Suite 400, 802 W. Bannock, P.O. Box 298, Boise, ID, 83701-0298, US

(21) Appl. No.: 11/243,096

(22) Filed: Oct. 3, 2005

Related U.S. Application Data
(60) Provisional application No. 60/615,436, filed on Oct. 1, 2004.

(51) Int. Cl. H02H 7/16

(52) U.S. Cl. 361/15

(57) ABSTRACT

In one embodiment, an electronic device comprises a plurality of electrical switches and a plurality of energy storage elements arrayed relative to one another such that the energy storage elements may be connected in series, or in parallel, or both, to an input and an output.

### CROSS REFERENCE TO RELATED APPLICATIONS

This Application claims subject matter described in copending provisional patent application Ser. No. 60/615,436 filed Oct. 1, 2004. This Application is entitled to the benefit of the filing date of provisional application Ser. No. 60/615,436 under 35 U.S.C. § 120.

### BACKGROUND

Integrated microbatteries are being developed as reliable low noise voltage sources for system-on-chip applications in the aerospace industry. Integrated microbatteries help provide localized current capacities or embedded power supplies at the chip level. Embodiments of the present invention were developed for charging and discharging integrated microbatteries.

### BRIEF DESCRIPTION OF THE DRAWINGS

FIG. 1 illustrates an array of switches and energy storage elements according to one embodiment of the invention.

FIG. 2 illustrates the array of FIG. 1 configured for charging one storage element.

FIG. 3 illustrates the array of FIG. 1 configured for charging multiple storage elements in parallel.

FIG. 4 illustrates the array of FIG. 1 configured for discharging multiple storage elements in series.

FIG. 5 illustrates the array of FIG. 1 configured for discharging multiple storage elements in parallel.

FIG. 6 illustrates the array of FIG. 1 configured for discharging multiple storage elements in series and in parallel. Fig.

FIGS. 7-10 illustrate an array of switches and energy storage elements according to another embodiment of the invention. FIG. 7 illustrates the array configured for charging one storage element. FIG. 8 illustrates the array configured for charging multiple storage elements in parallel. FIG. 9 illustrates the array configured for discharging multiple storage elements in series. FIG. 10 illustrates the array configured for discharging multiple storage elements in parallel.

FIG. 11 illustrates a power management system for an array of rechargeable batteries.

FIG. 12 illustrates one configuration for the interconnection of the components of the power management system of FIG. 11.

FIG. 13 illustrates one exemplary configuration for charging circuitry in the system of FIG. 11.

FIG. 14 illustrates one exemplary configuration for a charging controller in the system of FIG. 11.

FIG. 15 illustrates one exemplary configuration for communication signals between components in the system of FIG. 11.

FIG. 16 illustrates one exemplary set of input and output control words for charging circuitry, a charging controller and a switching controller in the system of FIG. 11.

FIGS. 17 and 18 illustrate exemplary configurations for input and output interface circuitry in the system of FIG. 11.

FIG. 19 illustrates a tree decoder circuit.

FIG. 20 illustrates components of a switch controller.

FIG. 21 illustrates a voltage generator circuit.

### DETAILED DESCRIPTION

### Energy Storage Element and Switch Array

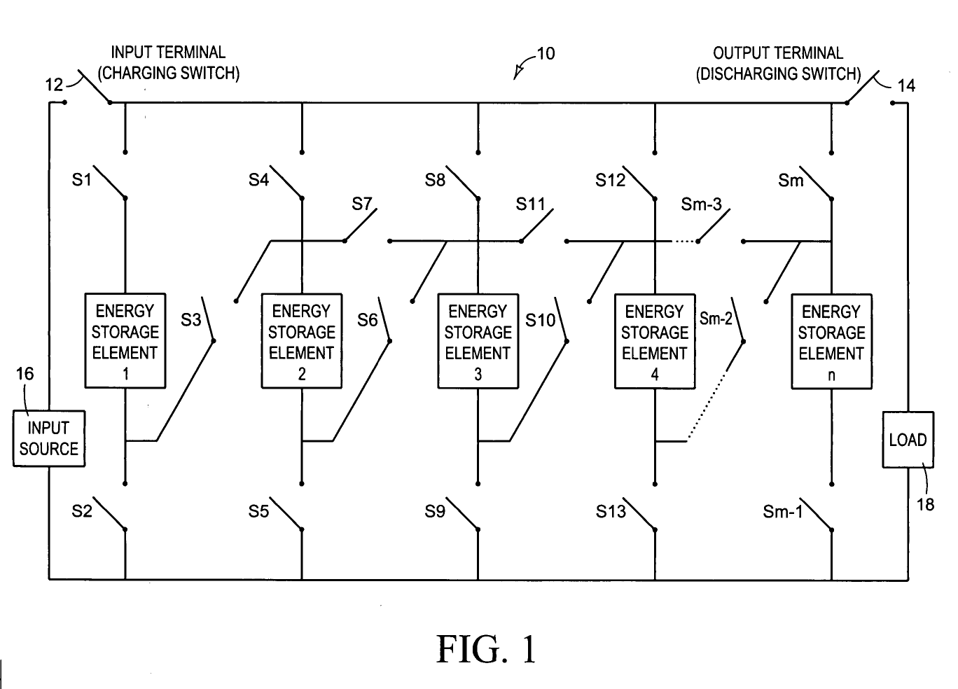

FIG. 1 illustrates an array 10 of switches S1-Sm and energy storage elements E1-En. Switches S and storage elements E are arrayed relative to one another such that storage elements E may be connected in series, or in parallel, or both, to an input or an output. Storage elements E are accessed through an input terminal 12 and an output terminal 14. Input terminal 12 will typically be configured as a charging switch through which storage elements E may be charged by an input voltage/current source 16. Output terminal 14 will typically be configured as a discharging switch through which storage elements E may be discharged to a load 18.

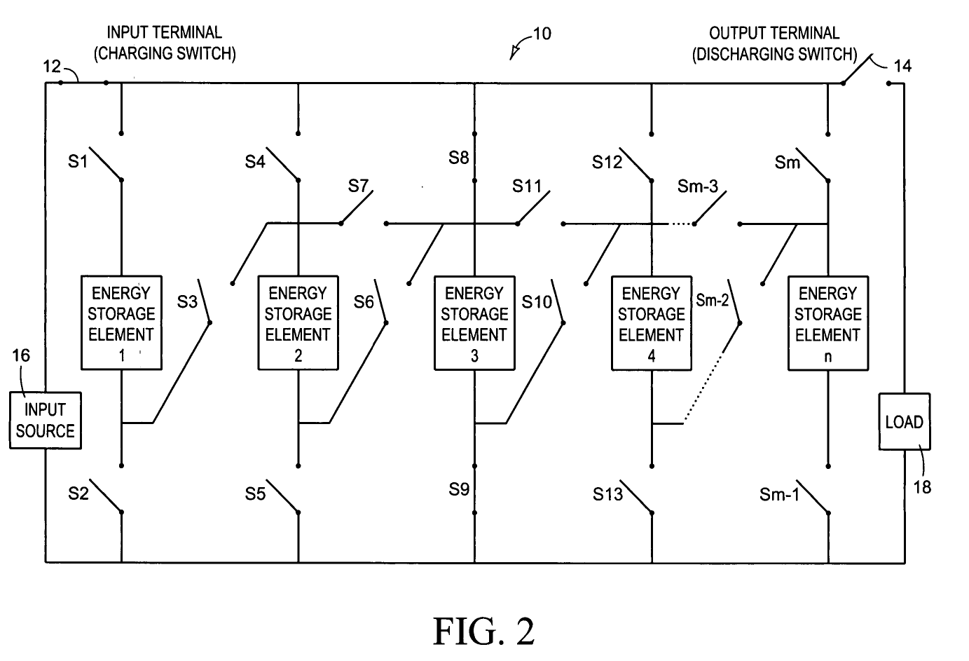

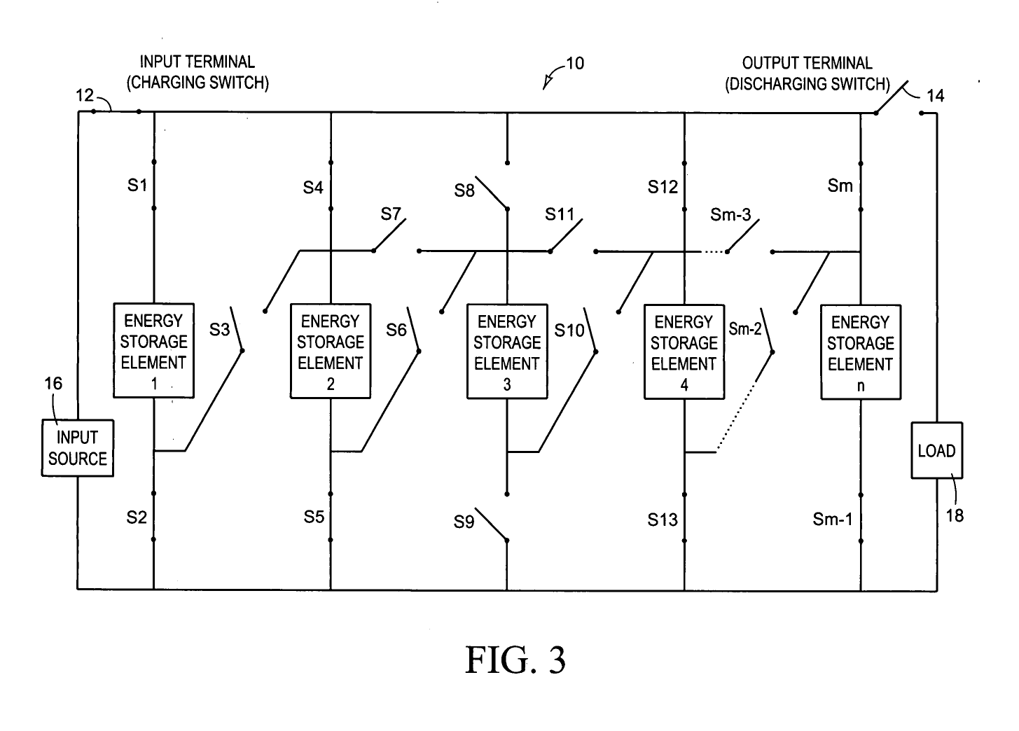

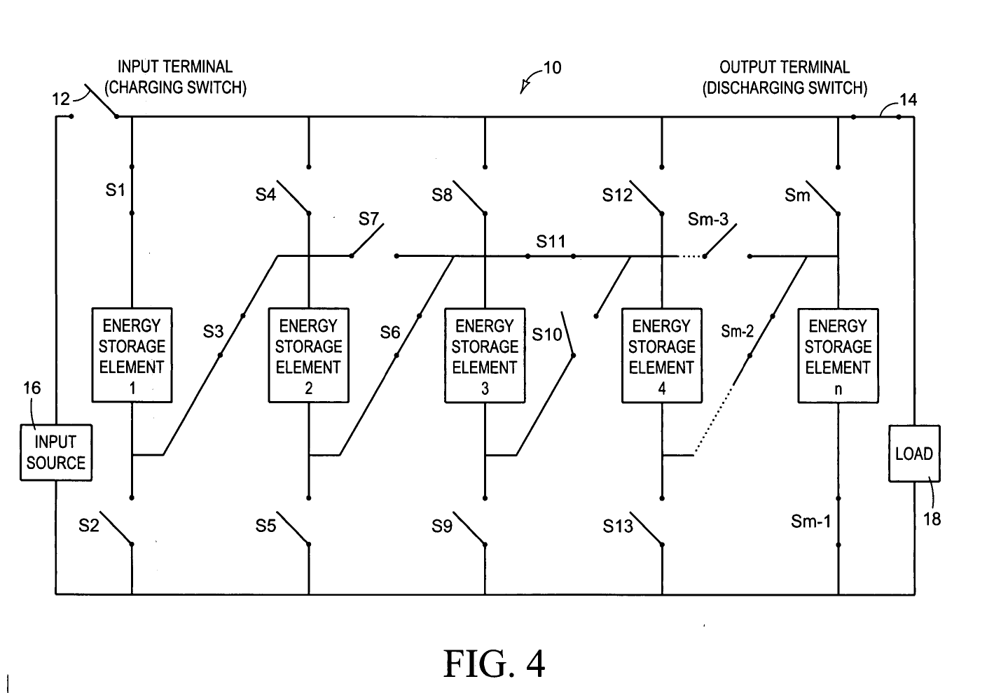

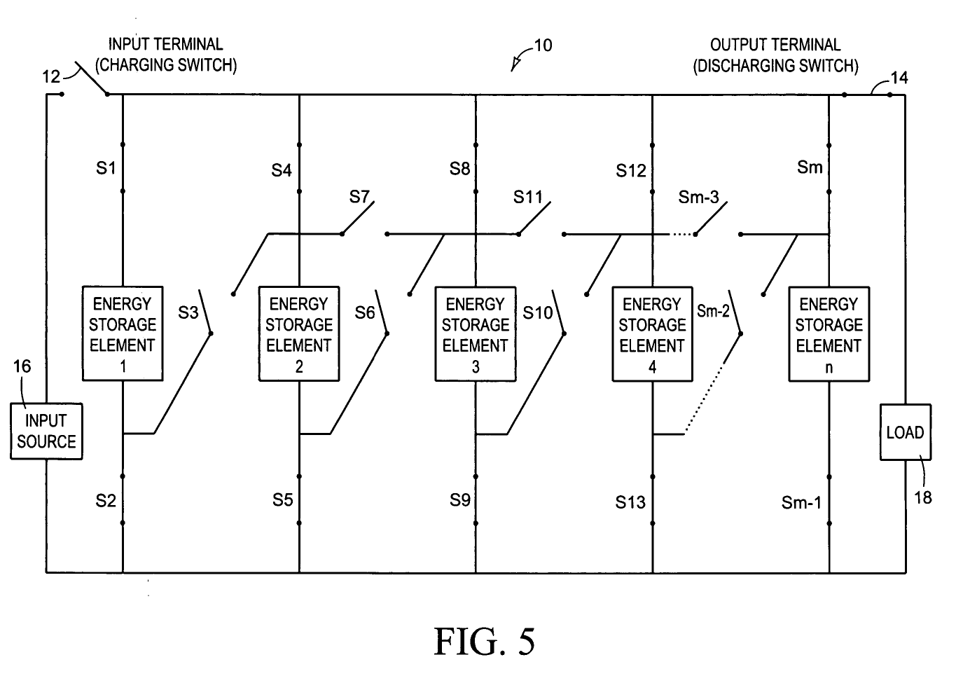

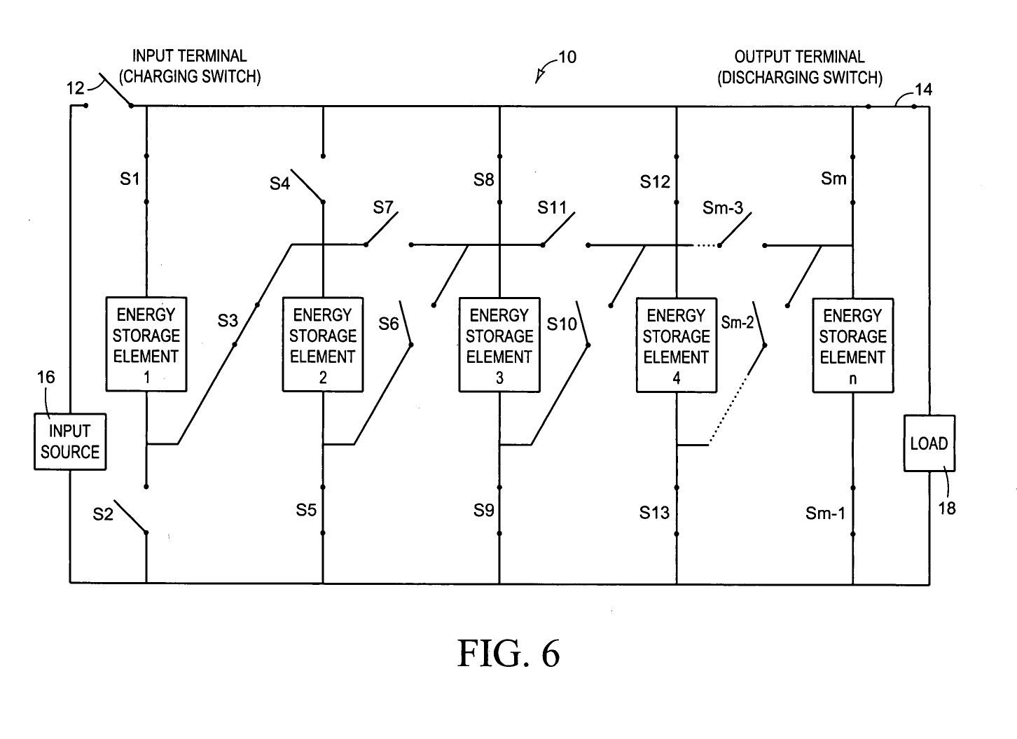

FIGS. 2-6 illustrate a few exemplary configurations of array 10. FIG. 2 illustrates array 10 configured for charging a single storage element E3. In FIG. 2, charging switch 12 and switches S8 and S9 are closed to allow a charging current from input source 16 to flow through storage element E3. FIG. 3 illustrates array 10 configured for charging storage elements E1, E2, and E4-En in parallel. In FIG. 3, charging switch 12 and switches S1, S2, S4, S5, S12, S13, Sm and Sm-1 are closed to allow a charging current to flow in parallel through storage elements E1, E2, and E4-En. FIG. 4 illustrates array 10 configured for discharging storage elements E1, E2, and E4-En in series. In FIG. 4, discharging switch 14 and switches S1, S3, S6, S11, Sm-2 and Sm-1 are closed to allow current flow in series from storage elements E1, E2, and E4-En to load 18. FIG. 5 illustrates array 10 configured for discharging storage elements El-En in parallel. In FIG. 5, discharging switch 14 and switches S1, S2, S4, S5, S8, S9, S12, S13, Sm and Sm-1 are closed to allow current flow in parallel from storage elements E1-En to load 18. FIG. 6 illustrates array 10 configured for discharging multiple storage elements in series and in parallel. In FIG. 6, discharging switch 14 and switches S1, S3, S5, S8, S9, S12, S13, Sm and Sm-1 are closed to allow current flow in series through storage elements E1 and E2 and in parallel through storage elements E1/E2, E3, E4 and En.

Array 10 may be configured for single storage element charging by connecting one storage element to the charge terminal, or multiple storage element charging by connecting multiple storage elements in parallel to the charging terminal. Array 10 may also be configured for greater voltage output by connecting multiple storage elements in series. Array 10 may be configured for greater current output by connecting multiple storage elements in parallel. Array 10 may be configured for varying the ratio of current to voltage output by varying the combination of storage elements connected in series and in parallel. Faulty storage elements can be individually isolated to minimize the effect on the overall performance of the array.

Energy storage elements E1-En each represent generally any suitable energy storage element including, for example, a battery, a capacitor or a power source. Switches 12 and 14 and S1-Sm each represent generally any suitable switching circuit or mechanism including, for example, a field effect transistor, a relay, a diode or a MEMS (micro-electromechanical systems) device.

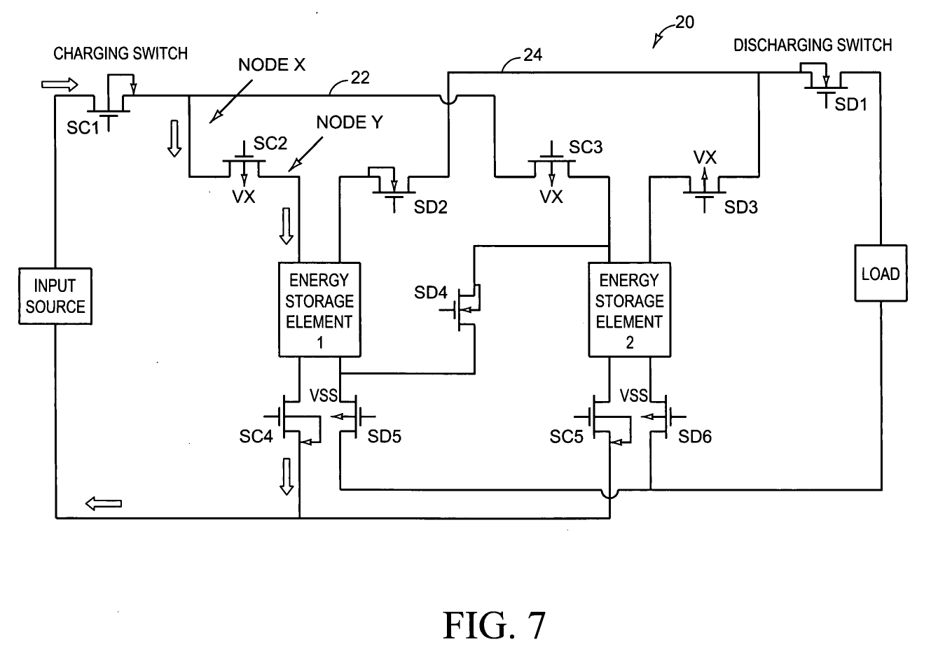

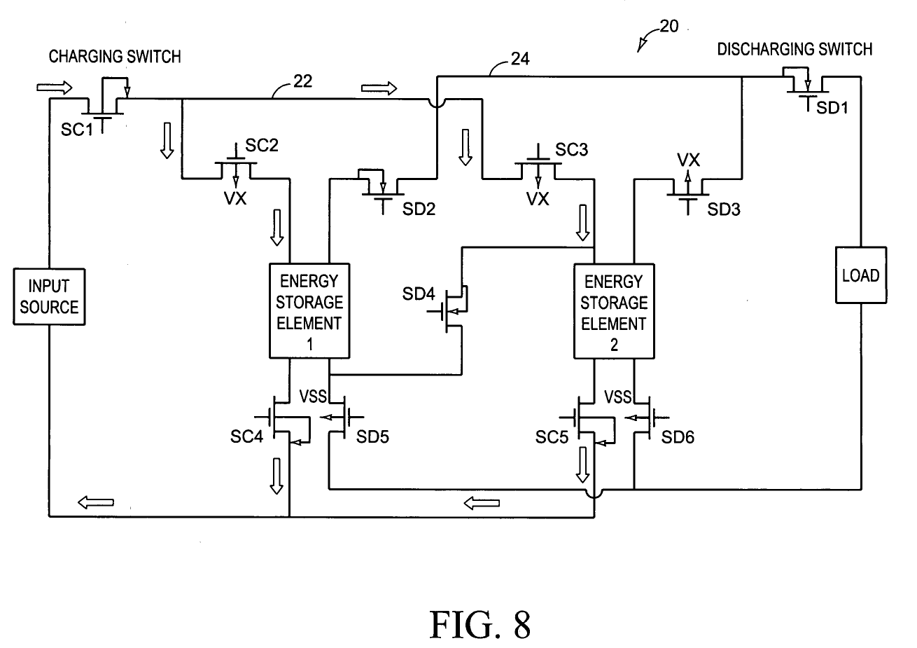

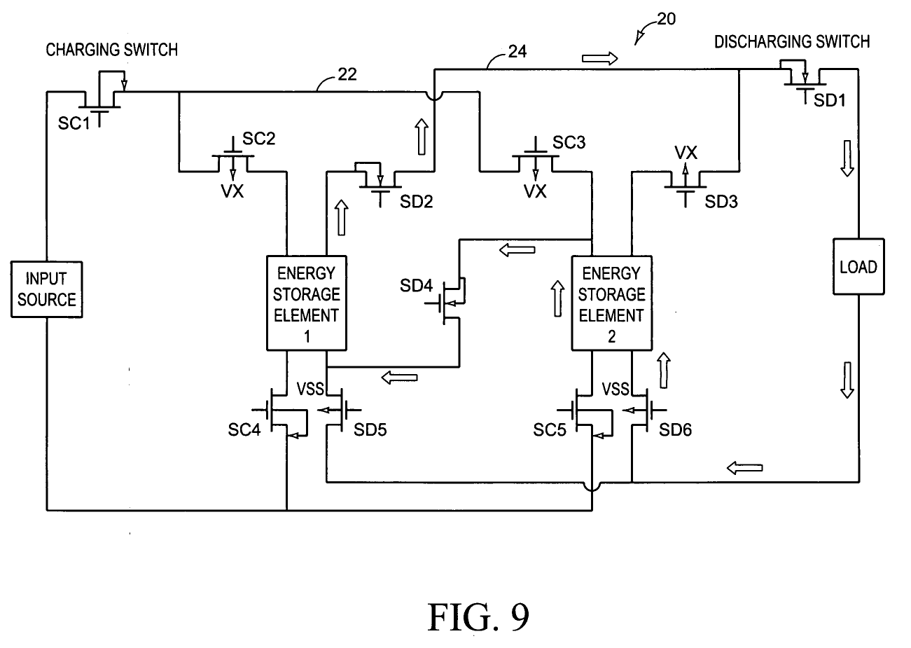

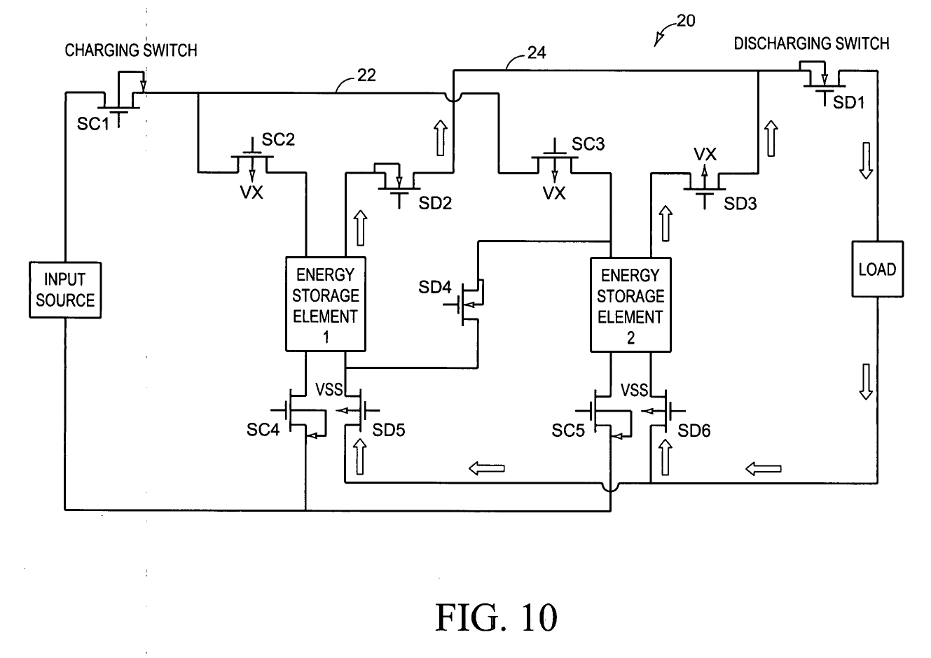

For some switching technologies, MOI (microwave on insulator) switches for example, it may be necessary or desirable to use separate switches for charging and discharging energy storage elements. FIGS. 7-10 illustrate an array 20 of energy storage elements E1 and E2, switches SC1-SC5 on a charging circuit 22 and switches SD1-SD6 on a discharging circuit 24. Switches SC1-SC5 and SD1-SD6 represent an IC (integrated circuit) switch such as, for example, an MOI switch. In FIG. 7, array 20 is configured for charging a single storage element E1. In FIG. 8, array 20 is configured for charging plural storage elements E1 and E2 in parallel. In FIG. 9, array 20 is configured for discharging plural storage elements E1 and E2 in series. In FIG. 10, array 20 is configured for discharging plural storage elements E1 and E2 in parallel.

It is now possible to fabricate very small solid-state rechargeable batteries on an IC chip. Such small scale batteries are often referred to as microbatteries. The capacity and current rating of a microbattery is limited. Some miniaturized systems require higher capacities and voltages than a single microbattery can provide. An array of microbatteries such as the array shown in FIG. 1 formed as part of an IC provides maximum voltage and capacity flexibility at the chip level. Using MOI switches, it is desirable that the switches are capable of handling a high value of drain-to-source voltage without experiencing electrical breakdown. Switches that are used for both charging and discharging a storage element, switch S1 in the array of FIG. 1 for example, can be bi-directional using bulk CMOS technology for the switches. It is desirable that the forward voltage drop associated with each switch during charging be as small as possible. To retain a fully charged microbattery, storage element E1 in the array of FIG. 1 for example, then switch S1 must be fully off with no leakage. If switch S1 leaks, then microbattery E1 would lose charge through switch S1. High voltage MOS (metal oxide semiconductor) switches have been found to satisfy desirable leakage requirements (−5 pA).

Separate circuits may be used for charging and discharging microbatteries as shown in FIGS. 7-10. In one exemplary implementation, the charging current is limited to a 1C (5 OnAH) rating of the microbattery, which is equivalent to 50 nA of current. Using MOI switches, the gate voltages for each MOS switch are provided by a gate driver controller. At any time in a charge cycle, the voltage of the microbattery should be known because the microbattery voltage determines the gate voltage of the charging switch. For example, if a microbattery E1 in FIG. 7 voltage is at 4.10V, then the microbattery requires a charging current to reach an end-of-charge threshold value of 4.25V. If the gate voltage of switch SC2 is kept at 5V, then switch SC2 is not in a strong inversion region which tends to limit the amount of charging current going into microbattery E1. Increasing the gate voltage of switch SC2 to a higher value, e.g. 6V, helps overcome this limitation. However, maintaining this higher gate voltage when the microbattery voltage is at 0V could lead to gate oxide breakdown in switch SC2. Switch SC2 has an isolated bulk because, when microbatteries E1 and E2 are connected in series, the positive side of E1 is raised to a potential of 8.50V (4.25V*2). This forward biases the internal p-n diode formed between the source and bulk, yielding an undesirable flow of current across the switch. This undesirable current flow can be eliminated by isolating the bulk and reverse biasing the p-n diode.

It is desirable to charge all microbatteries in an array at the same time to obtain equal microbattery voltages. Although microbatteries can be charged in series, series charging is not practical because it is difficult to balance the microbattery voltages. Parallel charging, as shown in FIGS. 3 and 8 (using MOI switches), offers the advantage of the microbatteries automatically maintaining the same voltage. In the configuration shown in FIG. 8, switch SC3 has an isolated bulk and holds the same explanation as noted above for switch SC2.

Discharging microbatteries in series, as shown in FIGS. 4 and 9 (using MOI switches), increases supply voltages at the chip level and, therefore, may eliminate area used by power supply circuits. Ideally, for microbatteries with a full-scale voltage reading of 4.25V, it is possible to provide 8.50V using two batteries for a period of one hour before the microbatteries reach their threshold voltage value. Maintaining the gate voltage for switch SD2 at 5V, so that the switch exhibits an automatic disconnect behavior when the combined cell voltage reaches 6V, limits the voltage of each microbattery to 3V (assuming identical microbatteries). Discharging microbatteries in parallel, as shown in FIGS. 5 and 10 (using MOI switches), increases current capacities to the load. For microbatteries rated at 50 nAH, it is possible to provide 100 nA of current to the load for one hour before the microbatteries reach the lower end-of-charge threshold voltage. P-channel MOS switches SD1 and SD2 pulled low forces each switch to operate in a strong inversion region to harness maximum energy from the microbatteries. Higher current capacities can be obtained by increasing the number of parallel microbatteries in the array.

### Power Management System

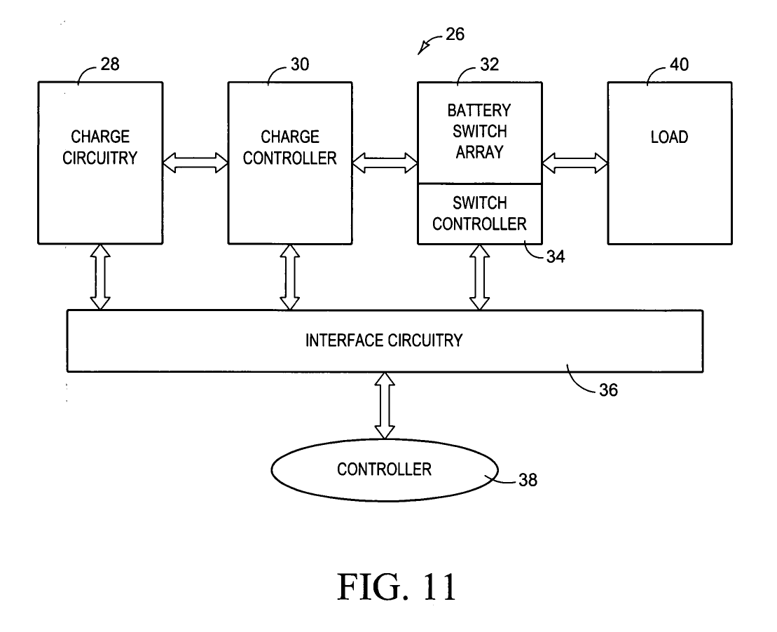

A new microprocessor based power management system that utilizes an array of batteries or other energy storage elements and switches, such as array 10 in FIG. 1 or array 20 in FIG. 2, will now be described with reference to FIGS. 11-17. Embodiments of the new system help the user select charging and discharging methods suitable for the battery or the load. Also, embodiments of the system allow the user to select the desired capacity or voltage output by connecting the N-batteries in the array in parallel, in series or in parallel and series. Embodiments of the system allow real time monitoring, battery status information and fault tolerant capabilities by detecting and isolating faulty batteries.

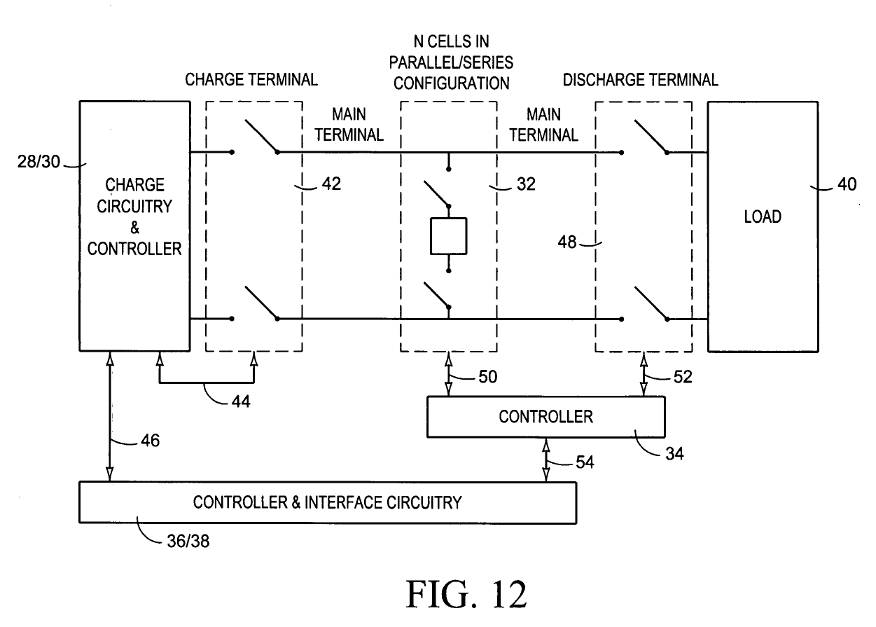

FIG. 11 is a block diagram illustrating a power management system 26 for an array of rechargeable batteries. Referring to FIG. 11, system 26 includes charging circuitry 28, a charge controller 30, a array 32 of rechargeable batteries and connecting switches, a switching controller 34 for array 32, input/output interface circuitry 36, and a system controller 38. A load 40 may also be included as part of system 26. FIG. 12 illustrates one configuration for the interconnection of the components of system 26. Referring to FIG. 12, charging circuitry 28 and charging controller 30 are connected to array 32 through a charging terminal 42 and a bi-directional connection 44. Charging circuitry 28 and charging controller 30 are connected to interface circuitry 36 and system controller 38 through a bi-directional connection 46. Load 40 is connected to array 32 through a discharging terminal 48. Switching controller 34 is connected to array 32 and discharging terminal 48 through bi-directional connections 50 and 52. System controller 38 and interface circuitry 36 are connected to switching controller 34 through a bi-directional connection 54.

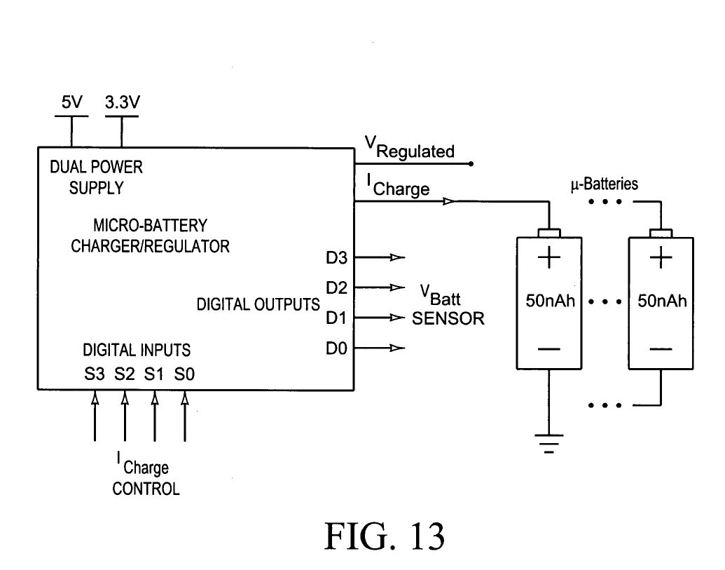

One exemplary configuration for charging circuitry 28 is shown in FIG. 13 (using MOI switches). The charging circuitry 28 shown in FIG. 13, which was developed by the University of Tennessee, provides a digitally adjustable output current in increments of 50 nA up to a maximum of 750 nA. The output current is controlled using a four-bit, current-mode digital to analog converter (DAC). Controller 38 is responsible for sending the four-bit control word to charging circuitry 28. The constant voltage charging capability of 4.25V is implemented using a using a voltage regulator circuit. A flash analog to digital converter (ADC) constantly monitors battery voltage and signals controller 38 when a battery is at full voltage capacity.

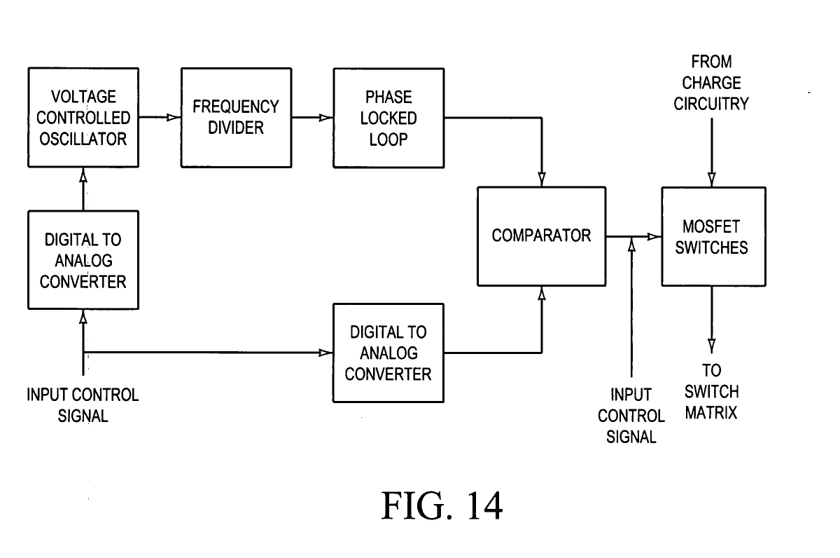

One exemplary configuration for charging controller 30 is shown in FIG. 14. The charging controller 30 shown in FIG. 14 provides additional charge flexibility to the user by allowing pulse charging to be incorporated into the charging mechanism. For a user defined input control word, an input constant frequency is given to the frequency divider by a voltage controlled oscillator. This frequency dictates the voltage going into the analog comparator, thereby controlling the duty cycle of operation of the switches in array 32. In other words, pulse charging is accomplished by pulse width modulating the continuous current from charging circuitry 28.

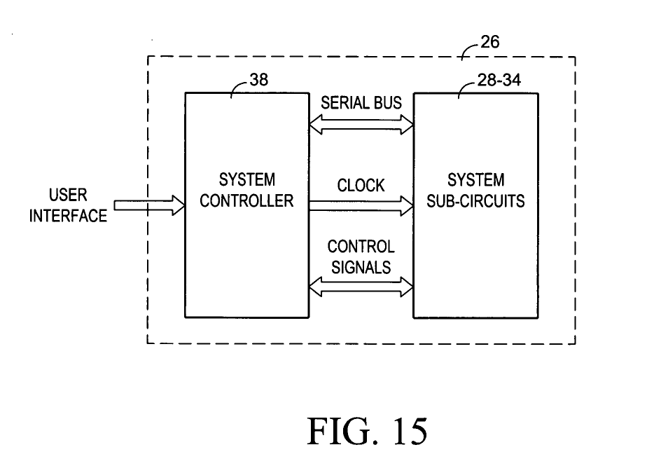

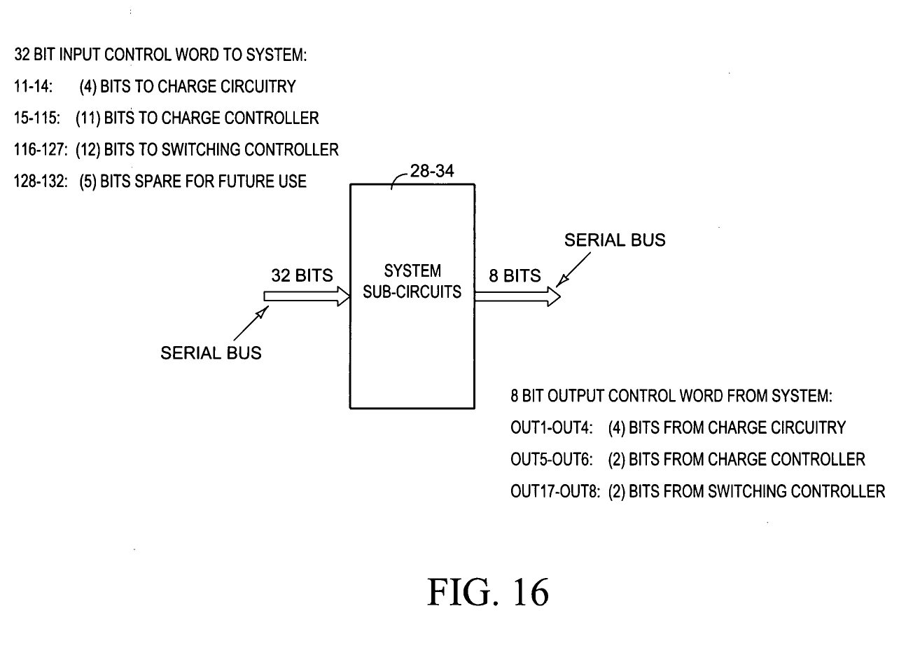

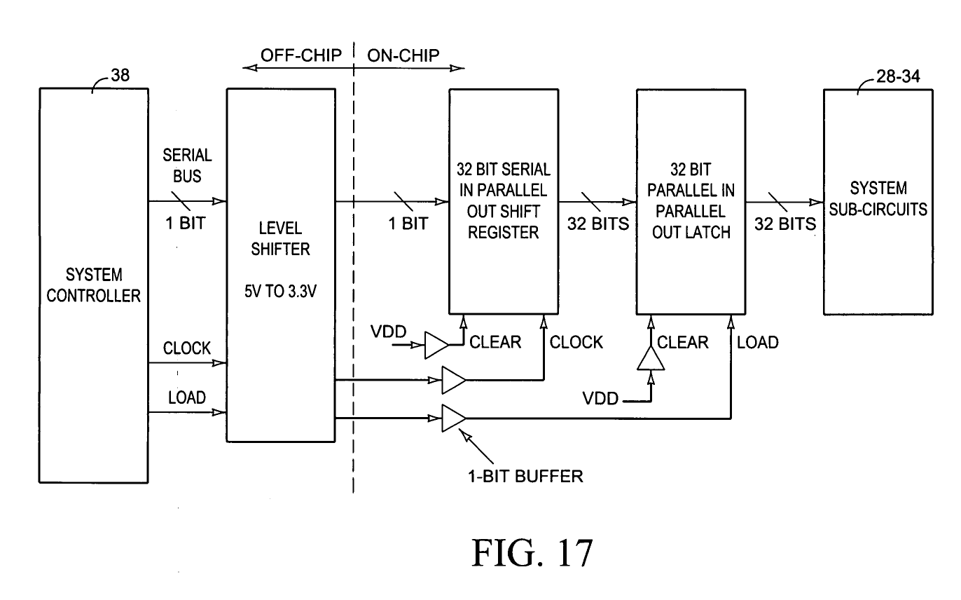

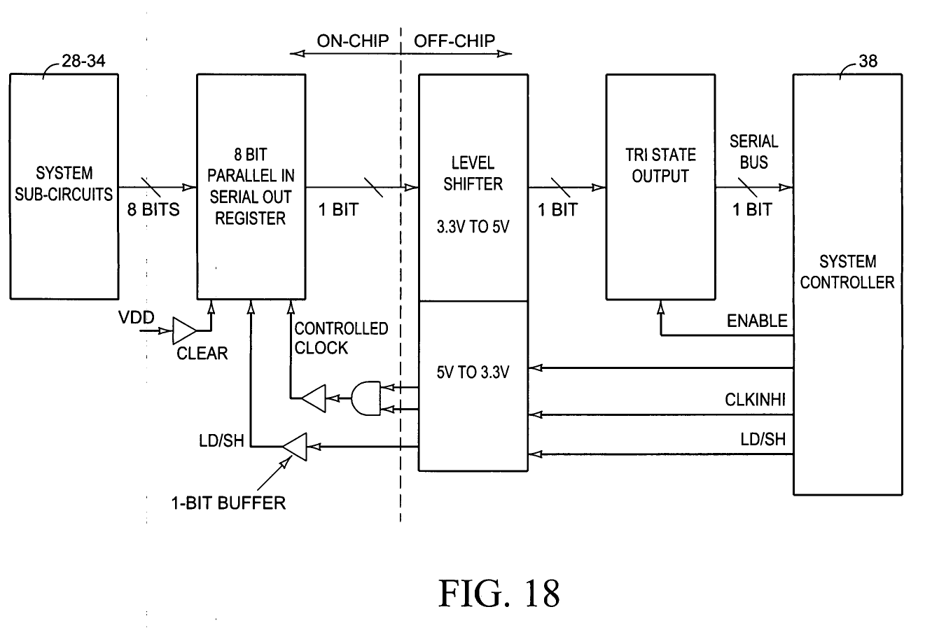

Switching controller 34 provides signals to control the switches in array 32, according to the desired configuration selected by the user, including isolating a faulty battery to provide fault tolerance in the array. I/O interface circuitry 36 allows system controller 38 to communicate with individual circuits in system 26. System controller 38 is a software/hardware microprocessor architecture configured to monitor and control the operation of the individual components in system 26. FIG. 15 illustrates one exemplary configuration for communication signals between system controller 38 and the other components of system 26. FIG. 16 illustrates one exemplary set of input and output control words for charging circuitry 28, charging controller 30 and switching controller 34. FIGS. 17 and 18 illustrate exemplary configurations for I/O interface circuitry 36.

Using MOI switches as shown in FIGS. 7-10, switches SC1, SC2, SC3, SD3 typically will require three different voltages, battery voltage VB, 0V and 4V for example, to implement a desired grouping pattern using eleven MOS switches, as shown in Table I.

TABLE I

| SC1 | SC2 | SC3 | SC4 | SC5 | SD1 | SD2 | SD3 | SD4 | SD5 | SD6 | |
|---|---|---|---|---|---|---|---|---|---|---|---|
| VB | VB | 0 V | 5 V | 0 V | 5 V | 5 V | 0 V | 0 V | 0 V | 0 V | → A |
| VB | VB | VB | 5 V | 5 V | 5 V | 5 V | 5 V | 5 V | 0 V | 0 V | → B |
| 0 V | 0 V | 0 V | 0 V | 0 V | 0 V | 0 V | 0 V | 5 V | 5 V | 5 V | → C |
| 4 V | 4 V | 4 V | 0 V | 0 V | 5 V | 5 V | 4 V | 0 V | 0 V | 5 V | → D |

| SC2_BULK | SC3_BULK | SD3_BULK | |
|---|---|---|---|
| 0 V | 0 V | 0 V | → A |
| 0 V | 0 V | 0 V | → B |
| 0 V | 0 V | 0 V | → C |
| 4 V | 0 V | 4 V | → D |

A = Charging any microbattery.
B = Charging microbatteries in parallel.
C = Discharging microbatteries in parallel.
D = Discharging microbatteries in series.
VB = voltage of the microbattery.
SC1, SC2, SC3, SD3 → 2 bits of information.
Other Switches → 1 bit of information.

These voltages can be represented with two bits of digital information. The voltages for the other switches are limited to 0V or 4V/5V. These voltages can be represented with one bit of digital information. An eighteen bit digital word, therefore, is required to express the state of eleven MOS switches. Certain switches may be grouped because they require the same voltage level for any particular operating mode, as shown in Table II. Grouping reduces or compresses the number of bits needed to express the state of all eleven switches. As a result, switching controller 34 (FIG. 11) can control the switches through a six bit digital word.

TABLE II

| Switches that can be grouped together | |
|---|---|
| SC2_BULK, SC3_BULK, SD3_BULK | → Group A |
| SC1, SC2 | → Group B |
| SD1, SD2 | → Group C |
| SC4, SD6 (Inverse of SC4) | → Group D |

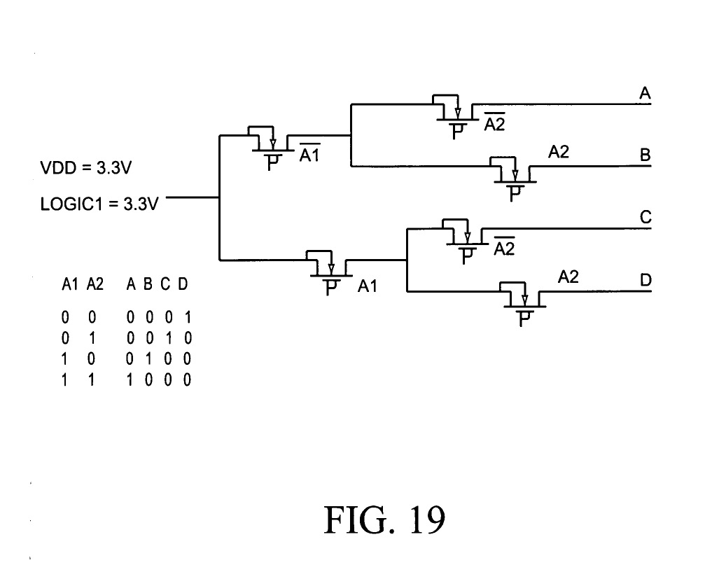

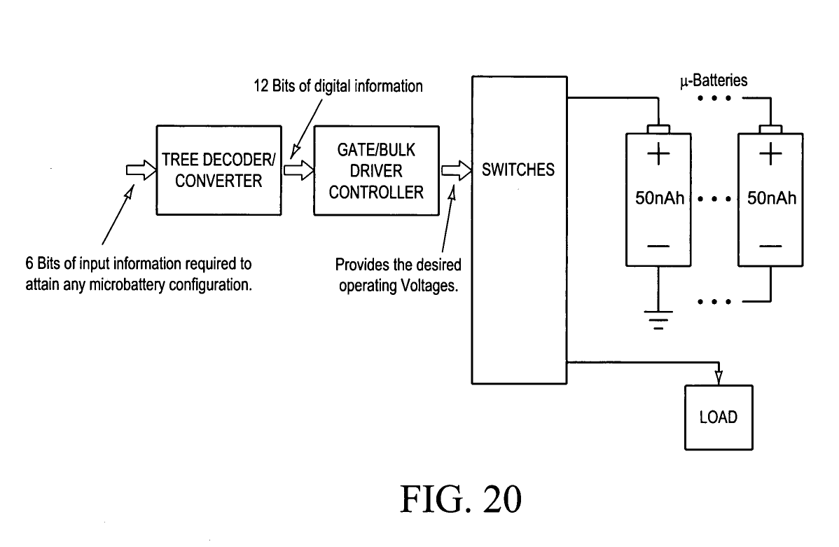

Again, using MOI switches, six input lines are converted to a twelve bit signal using a tree decoder circuit. As shown in FIG. 19, the tree decoder circuit has two address lines A1, A2 to enable the pass transistors used in the decoder. One of the four outputs is pulled high, depending on the two bit address line. The supply line voltage (VDD) is 3.3V and the threshold voltage drop (Vth) experienced across each PMOS transistor is 0.81V. The outputs of the tree decoder are connected to a gate/bulk driver controller as seen in FIG. 20. As mentioned before, the gate voltage of some MOS Switches (SC1, SC2, SC3, and SD3) are set by the microbattery voltage (VB). To help attain the best possible MOS switch operation, three possible cases are possible.
Case No. 1: 3V<Battery Voltage<5V. It is desirable that the MOS switches operate in a strong inversion region. At the same time, it is also desirable to maintain the gate-source voltage of the MOS switches to eliminate gate oxide breakdown. A constant gate bias voltage of 6V is provided when the battery voltage is between 3V and 5V which limits the gate-source voltage to between 3V and 1V.
Case No. 2: 2V<Battery Voltage<3V. A gate voltage of 4V is provided when the battery voltage is between 2V and 3V which helps operate the MOS switches in a strong linear region.
Case No. 3: 0V<Battery Voltage<2V. For the MOS switches to operate in a strong saturation region, the gate voltage is maintained at 3.3V.

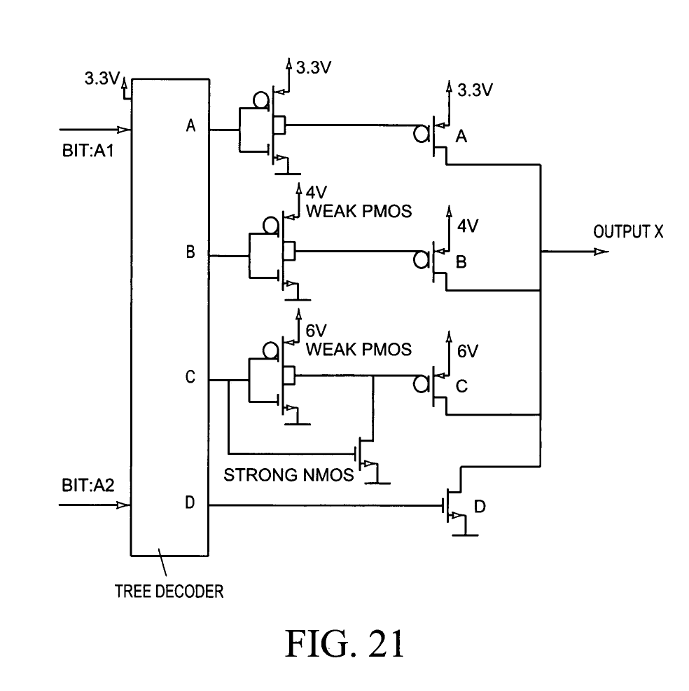

FIG. 21 illustrates a voltage generator configured to satisfy the operating cases mentioned above. In FIG. 21, input lines A-D are inputs from the tree decoder circuit (FIGS. 19 and 20). Output X pushes to a voltage level based on the input word. The supply voltage of the tree decoder circuit is tied to a 3.3V rail. As such, the output signal equals the supply rail value for a logic high condition. For inverter A, the logical effort for falling transition equals the rising transition. Unfortunately, this is not true for the other inverters. Inverter B will not produce a strong zero value because the PMOS will remain on even for logic high input. Introducing a weak PMOS structure solves this problem. The PMOS in inverter C is tied to a higher supply rail to effect the falling transition. A strong logic low is produced by connecting a strong N-channel MOS structure in parallel to the N-channel MOS in Inverter C. The circuit of FIG. 21 holds true only for switches SC1, SC2, SC3, and SD3 in FIGS. 7-10. The same principle may be used for other switches that require two voltage values (0V or 4V/5V) to satisfy any battery configuration.

The present invention has been shown and described with reference to the foregoing exemplary embodiments. It is to be understood, however, that other forms, details, and embodiments may be made without departing from the spirit and scope of the invention which is defined in the following claims.

1. An electronic device, comprising a plurality of electrical switches and a plurality of energy storage elements arrayed relative to one another such that energy storage elements may be connected in series and/or, in parallel, to an input and/or an output.

2. The device of claim 1, wherein each energy storage element comprises a battery or a capacitor.

3. The device of claim 2, further comprising an input and an output.

4. The device of claim 3, wherein the input comprises a source of electric current and the device further comprising an electrical charging switch between the current source and the array of switches and storage elements.

5. The device of claim 3, wherein the output comprises an electrical load and the device further comprising an electrical discharging switch between the load and the array of switches and storage elements.

6. The device of claim 3, wherein each energy storage element comprises a battery or a capacitor, the input comprises a source of electric current, and the output comprises an electrical load, and the device further comprising an electrical charging switch between the source and the array of switches and storage elements and an electrical discharging switch between the load and the array of switches and storage elements.

7. The device of claim 1, wherein the switches and the storage elements are further arrayed such that each storage element may be isolated from the other storage elements and from an input and an output.

8. The device of claim 6, wherein the switches and the storage elements are further arrayed such that each storage element may be isolated from the source, the load and the other storage elements.

9. A charging circuit, comprising:
a source of electric current;
a plurality of energy storage elements;
a first plurality of electrical switches, each of the storage elements connected to the current source through a corresponding switch in the first plurality of switches; and
a second plurality of electrical switches, each of the energy storage elements connected to each of the other storage elements through corresponding switches in the second plurality of switches.

10. The charging circuit of claim 9, further comprising an electrical charging switch between the current source and the first plurality of switches.

11. A discharging circuit, comprising:
an electrical load;
a plurality of energy storage elements;
a first plurality of electrical switches, each of the storage elements connected to the load through a corresponding switch in the first plurality of switches; and
a second plurality of electrical switches, each of the energy storage elements connected to each of the other storage elements through corresponding switches in the second plurality of switches.

12. The discharging circuit of claim 11, further comprising an electrical discharging switch between the load and the first plurality of switches.

13. A circuit, comprising:
a source of electric current;
an electrical load;
a plurality of energy storage elements;
a first plurality of electrical switches, each of the storage elements connected to the current source and the load through a corresponding switch in the first plurality of switches; and
a second plurality of electrical switches, each of the energy storage elements connected to each of the other storage elements through corresponding switches in the second plurality of switches.

14. The circuit of claim 13, further comprising:
an electrical charging switch between the current source and the first plurality of switches; and
an electrical discharging switch between the load and the first plurality of switches.

15. An electronic device, comprising:
a charging circuit including a source of electric current, a plurality of energy storage elements, a first plurality of electrical switches, each of the storage elements connected to the current source through a corresponding switch in the first plurality of switches, and an electrical charging switch between the current source and the first plurality of switches;
a discharging circuit including an electrical load, the plurality of energy storage elements, a second plurality of electrical switches, each of the storage elements connected to the load through a corresponding switch in the second plurality of switches, and an electrical discharging switch between the load and the second plurality of switches; and
a third plurality of electrical switches, each of the energy storage elements connected to another storage element through a corresponding switch in the third plurality of switches.

16. The device of claim 15, wherein some of the energy storage elements are connected to more than one of the other storage elements through corresponding switches in the third plurality of switches.

17. An integrated circuit, comprising:
an array of microbatteries; and
a plurality of CMOS (complementary metal oxide semiconductor) switches operatively connected to the microbatteries such that the microbatteries may be connected in series and/or in parallel to a current source and/or to a load.

18. The integrated circuit of claim 17, wherein at least some of the CMOS switches comprise MOI (microwave on insulator) switches.

19. An integrated circuit, comprising:
an array of microbatteries; and
a plurality of MOI (microwave on insulator) switches operatively connected to the microbatteries such that the microbatteries may be connected in series and/or in parallel to a current source and to a load and such that each microbattery may be isolated from the other microbatteries and from the current source and the load.
